(19) United States
(12) Patent Application Publication
(10) Pub. No.: US 2014/0325894 A1
(43) Pub. Date: Nov. 6, 2014

(54) GAS INJECTOR AND METHOD FOR DELIVERING GAS FOR PEST EXTERMINATION

(71) Applicant: Inert Gas Injection, LLC, Acampo, CA (US)

(72) Inventors: Alfred J. Dentone, Acampo, CA (US); Claude Edward Brown, Lodi, CA (US)

(73) Assignee: Inert Gas Injection, LLC, Acampo, CA (US)

(21) Appl. No.: 14/268,963

(22) Filed: May 2, 2014

Related U.S. Application Data
(60) Provisional application No. 61/820,057, filed on May 6, 2013.

(51) Int. Cl. A01M 17/00; F16L 27/087

(52) U.S. Cl. CPC A01M 17/002; F16L 27/087
USPC 43/125; 285/272; 137/342

(57) ABSTRACT

Devices and method for the extermination of pests are described. These devices and methods may be used to inject gases, which may be inert gases, underground to inject the gas into burrows of pests. In one embodiment, the device is an earth penetrator with hole for injecting gas through discharge holes at the distal end. The discharge holes maybe covered during penetration to prevent dirt from entering into the device. A device for covering and uncovering the hole are provided. The device includes a valve to controllably deliver the gas to the discharge ports. The method includes covering the discharge ports, inserting the device into the ground, uncovering the discharge ports, and then injecting the gas.

### CROSS-REFERENCE TO RELATED APPLICATIONS

This application claims the benefit of U.S. Provisional Application No. 61/820,057, filed May 6, 2013, the contents of which are hereby incorporated by reference in its entirety.

### BACKGROUND OF THE INVENTION

1. Field of the Invention

The present invention relates to pest control, and more particularly to devices and methods of delivering a gas for pest extermination.

2. Discussion of the Background

Burrowing rodent and/or other burrowing pests are particularly difficult to eradicate. Prior art methods of burrowing animal extermination include trapping, explosion using propane and oxygen injection, poison baiting using grains or pellets treated with zinc phosphide or other rodenticide, and burrow fumigating. The foregoing prior art techniques leave room for improvement.

Techniques that require manual location of the burrow are very labor intensive. This includes trapping and the burrow locating procedures required for known solid fumigant placement and manual bait placement techniques.

The use of explosions or fumigants present physical and/or chemical hazards having obvious undesired effects, such as the possible release of chemicals in to the environment and hazards to humans who are applying toxic fumigants in a manual fashion, for example due to the potential for accidental exposure to the toxic fumes.

In view of the forgoing, there is a desire for an improved method of pest control effective against burrowing rodents. Such methods should be non-toxic and easy to use.

### BRIEF SUMMARY OF THE INVENTION

The present invention overcomes the disadvantages of prior art by providing a device and method for delivering a gas, such as an inert gas, below the surface of the ground. It is one aspect of the present invention to provide an apparatus for providing gas from a gas source, where the apparatus includes a proximal end and a distal end adapted for delivering the gas. The apparatus includes: a first tube having a proximal portion near the proximal end and a distal portion near the distal end and including one or more holes through the wall of the first tube; a second tube coaxial with and disposed within the first tube, where the second tube has a proximal portion and a distal portion near the distal end and including one or more holes through the wall of the second tube; a port to accept gas from the gas source; and a passageway to provide fluid communication between the port and the one or more holes of the first tube. The first tube and second tube are rotatably movable between: a first configuration, wherein at least one hole of the first tube is aligned with at least one hole of the second tube, and a second configuration, wherein none of the one or more holes in the first tube align with any of the one or more holes of the second tube.

It is another aspect of the present invention to provide an apparatus for providing gas from a gas source. The apparatus includes: a valve including a gas inlet to accept gas from the gas source; a tube having a proximal portion and a distal portion, where the proximal portion includes a handle and is in fluid communication with the valve, and the distal portion includes one or more openings through the tube and a pointed tip; and means for covering the one or more openings.

It is yet another aspect of the present invention to provide a method of delivering a gas into the ground using a gas injector. The gas injector has a proximal end and distal end, and an outer tube and a coaxial inner tube rotationally mounted to each other and which both extend from near the proximal end to near the distal end, where the inner tube is adapted to accept a gas, and where the outer tube includes discharge ports and a pointed tip near the distal end. The method includes: covering the discharge ports; inserting the pointed tip into the ground; uncovering the discharge ports; and activating the flow of a gas through the discharge ports.

These features together with the various ancillary provisions and features which will become apparent to those skilled in the art from the following detailed description, are attained by the gas injector and method of injecting gas under the ground of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a first perspective view of an embodiment of a gas injector assembly in a closed configuration;

FIG. 2 is a first perspective view of the gas injector assembly of FIG. 1 in an open configuration;

FIG. 3 is a sectional view 3-3 of the gas injector assembly in a closed configuration, as in FIG. 1;

FIG. 4 is a second perspective view of the gas injector assembly in a closed configuration, as in FIG. 1;

FIG. 5 is a sectional view 5-5 of the gas injector assembly in a closed configuration, as in FIG. 1;

FIG. 6 is a sectional view 6-6 of the gas injector assembly in an open configuration, as in FIG. 2;

FIG. 7 is a second perspective view of the gas injector assembly in an open configuration, as in FIG. 2; and

FIG. 8 is a third perspective view of the gas injector assembly in a closed configuration, as in FIG. 1.

Reference symbols are used in the Figures to indicate certain components, aspects or features shown therein, with reference symbols common to more than one Figure indicating like components, aspects or features shown therein.

### DETAILED DESCRIPTION OF THE INVENTION

While the present invention is described herein with reference to specific embodiments, the description is merely illustrative and is not to be construed as limiting the invention. Thus, modifications to the embodiments may be made without departing from the true spirit and scope of the invention as defined by the appended claims. It will be noted here that for a better understanding, like components are designated by like reference numerals throughout the various figures.

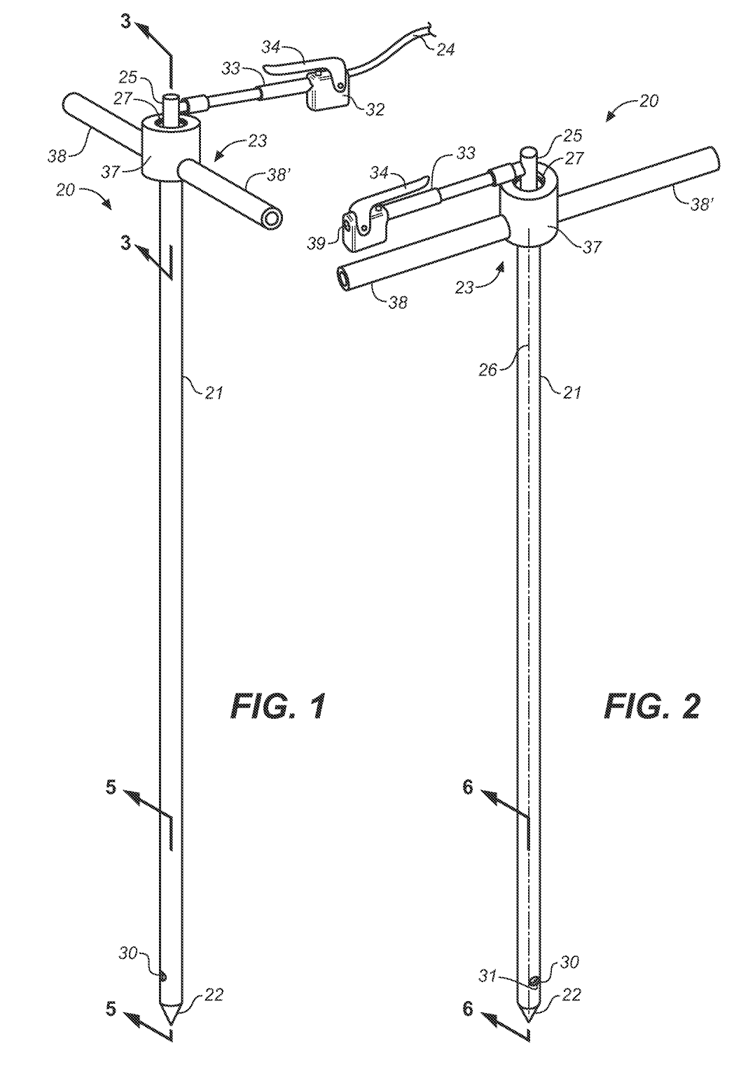

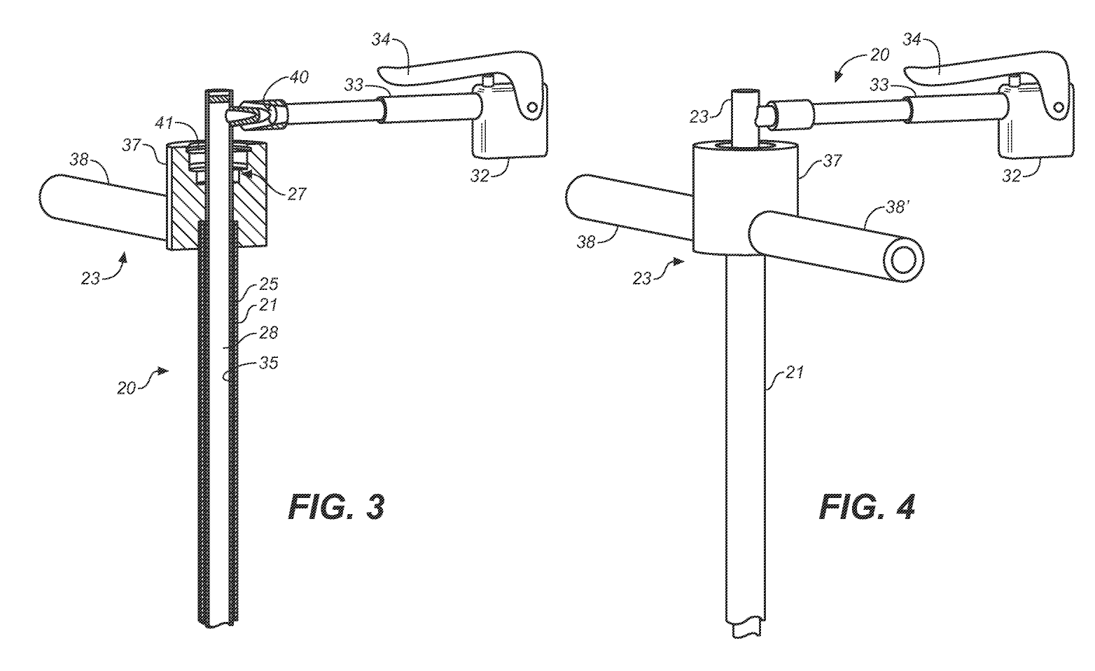

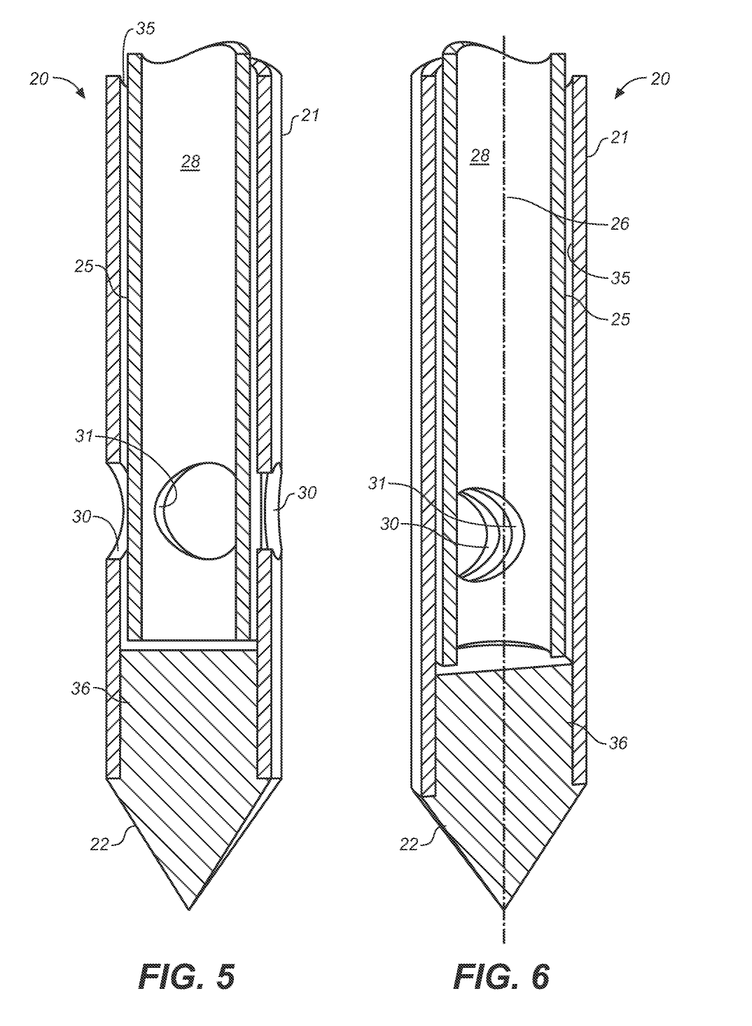

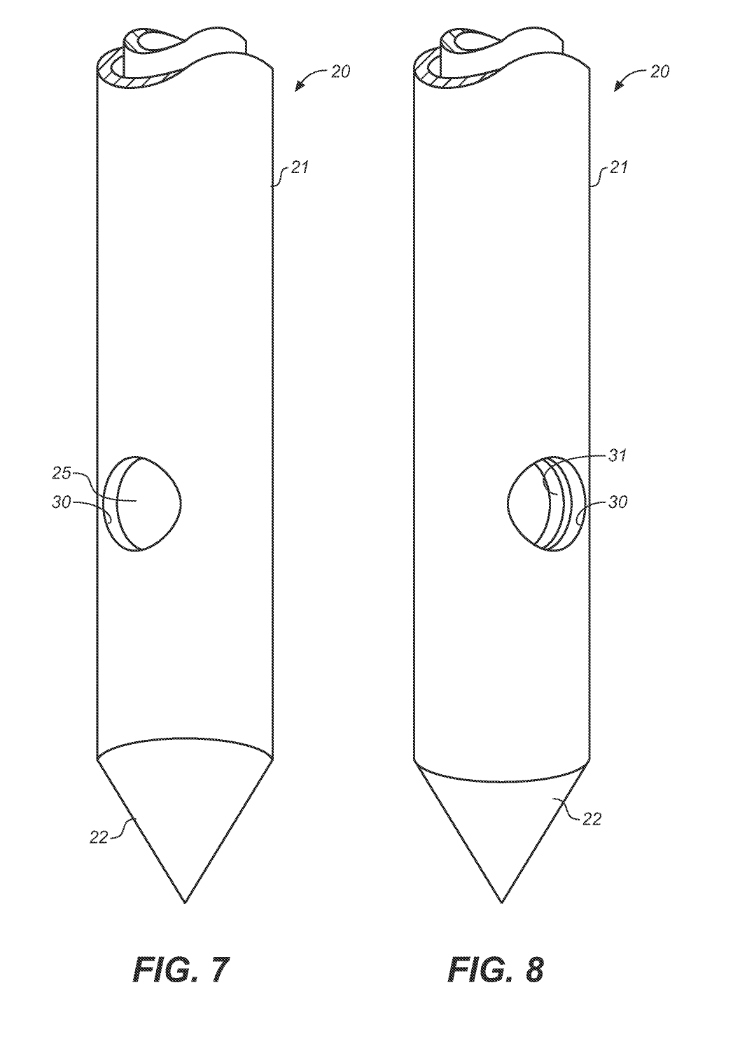

Turning now to FIGS. 1-8, an gas injector assembly, generally designated 20, is shown and provided for pest extermination, where FIG. 1 is a first perspective view of the gas injector assembly in a closed configuration; FIG. 2 is a first perspective view of the gas injector assembly in an open configuration; FIG. 3 is a sectional view 3-3 of the gas injector assembly in a closed configuration; FIG. 4 is a second perspective view of the gas injector assembly in a closed configuration; FIG. 5 is a sectional view 5-5 of the gas injector assembly in a closed configuration; FIG. 6 is a sectional view 6-6 of the gas injector assembly in an open configuration; FIG. 7 is a second perspective view of the gas injector assembly in an open configuration; and FIG. 8 is a third perspective view of the gas injector assembly in a closed configuration.

Injector assembly 20 includes an elongated, hollow, penetration tube 21 defining a tube passage 35 extending axially therethrough. A distal portion of penetration tube 21 includes opposed outer discharge ports 30 through the tube and oriented proximate to the distal portion of the tube, and a pointed penetrating tip member 22. An opposing, proximal portion of penetration tube 21 includes a handle portion 23. Handle portion 23 supports opposed handle bars 38, 38′, a bearing housing 37, an intake tube 33 having an internal passageway 40, and a valve 32 having a trigger 34, where the valve is attached to passageway 40.

Valve 32 includes a port 39 which may be attached to a gas line 24 for accepting gas from a gas source (not shown). Valve 32 may be, for example and without limitation, a conventional 2-way control valves include push to discharge, simple on/off valves, for instance. In the embodiments illustrated, valve 32 is a model 600NTIW blowgun, manufactured by Coilhose Pneumatics (East Brunswick, N.J. 08816), in which depressing trigger 34 permits gas to flow therethrough.

As shown in FIG. 3, penetrator tube 21 defines a tube passage 35 and is attached to bearing housing 37, and injection tube 25, defining an interior passageway 28, is disposed within bearing housing 37 and tube passage 35. In one embodiment, a bearing member 41 in bearing housing 37 provides rotational support to the injection tube 25 relative to the penetration tube 21. This bearing also longitudinally fixes the injection tube 25 such that the distal end thereof softly seats against the tip member 22. Load bearing member 41 may be, for example, a snap ring.

Injection tube 25 includes a pair of inner discharge ports 31 which correspond to discharge ports 30, and is dimensioned for rotating movement about a common longitudinal axis 26 (as shown in FIGS. 2 and 6). Flow from the gas source may thus, upon depression of trigger 34, flow from valve 32, through passageways 40 and 28 and thus through discharge ports 30.

Handle bars 38, 38′ are thus attached, through bearing housing 37, to penetrator tube 21, and injector tube 25 is supported by load bearing member 41 of bearing housing 37, and is attached to intake tube 33 and valve 32. Rotation of handle bars 38, 38′ relative to intake tube 33 permits injector assembly 20 to be manually rotated between an “open configuration” in which discharge holes 30 and 31 are aligned (as shown in FIGS. 2, 6 and 8), and a “closed configuration” in which discharge holes 30 and 31 are misaligned (as shown in FIGS. 1, 3-5 and 7), both configurations of which will be described in greater detail below. The mechanism provided by co-axial tubes with holes that can be rotated into and out of alignment for a means for covering openings (discharge holes 30) of gas injector 20.

In one embodiment, the gas source connected to line 24 is a tank containing an inert gas, such as CO₂, for example. When trigger 34 of control valve 32 is pressed, gas may flow from the tank, through line 24 into a passage 28 formed by the interior of injection tube 25, as is discharged through a pair of opposed outer discharge ports 30 in penetration tube 21. This will be discussed in greater detail below.

The present invention is particularly suitable for ground penetration when exterminating ground burrowing rodents, such as mice, rats, moles, gophers, and other burrowing pests. It will be appreciated, however, that the present can be applied to pests living within the walls of a contained structure, such as insects and/or mice. Briefly, in accordance with the present invention, penetrating tip member 22 is inserted into the ground by applying a force to handle portion 23. During insertion of the gas injector assembly 20 into the ground, penetrator tube 21 and injector tube 25 are oriented in the closed configuration of FIG. 1.

Once the outer discharge ports 30 of the penetration tube 21 are placed at the proper orientation, such as when in fluid communication with a tunnel of a burrowing rodent and/or other burrowing pests, gas injector 20 may be manually moved from the closed configuration (FIGS. 1, 3-5 and 7) to the opened configuration (FIGS. 2, 6 and 8), thus aligning discharge ports 30 and 31. Depressing trigger 34 thus permits deliver of gas from gas injector 20.

Referring back to FIGS. 1, 2, 5 and 6, elongated outer penetration tube 21 is a tube composed of a rigid material that is capable of penetrating relatively hard soil, including but not limited to metal or a hard plastic. The penetration tube 21 defines a tube passage 35 extending axially therethrough, and the opposed outer discharge ports 30 at the distal portion of the tube. A penetration tip member 22, which is preferably composed of a hard metallic material to facilitate soil penetration. This tip member 22 includes a post portion 36 (FIGS. 5 and 6) that is press-fit into the distal opening into the tube passage 35.

Bearing housing 37 provides for rotational movement between the closed configuration and the opened configuration. Opposed handle bars 38, 38′ extend radially outward from the valve housing, forming a T-shape handle relative to the penetration tube 21. This shape facilitates easy operation of the handle portion 23 to penetrate soil with the penetration tube 21.

Turning now to FIGS. 3-6, the injection tube 25 is formed and dimensioned for rotational receipt within penetration tube passage 35. Hence the outer diameter of the injection tube is less than the inner diameter of the penetration tube passage 35 by an amount enabling unencumbered rotation within, while at the same time, not being too loose.

FIGS. 2, 6 and 8 best illustrate that at the distal portions of the injection tube 25 and penetration tube 21, it will be appreciated that in the open configuration, the opposed inner discharge ports 31 of the injection tube 25 is rotated about longitudinal axis 26 until it is generally in co-axial alignment with the opposed outer discharge ports 30 of the penetration tube, enabling discharge of the inert gas from inert gas injector assembly 20.

In contrast, in the closed configuration, the corresponding discharged ports 30, 31 are moved out of co-axial alignment, significantly reducing the passage of gas therethrough. Moreover, this alignment enables penetration of the inert gas injector assembly into the soil while preventing passage of soil into the inner communication passage 28 of the injection tube 25. In certain embodiments, the fit between the outer surface of injection tube 25 and the inner surface of passage 35 is sufficiently tight to inhibit the flow of gas when discharge ports 30, 31 are not aligned. In an alternative embodiment, additional sealing may be provided near port 31 to prevent the flow of gas when discharge portions 30, 31 are not aligned.

It will be appreciated that other inert gases can be applied such as nitrogen, for example. Also, the gas source is regulated to fill and displace available oxygen in the burrow or tunnel when discharged from the injection tube 25, generally in the range of about 1 psi to about 15 psi when the control valve is in the opened configuration.

When an inert gas (e.g., CO₂ gas) is discharged by gas injector assembly 20 into a burrow, that is heavier than air, it will settle to the bottom of the borrow. By covering the rodent's burrow entrance, the CO₂ gas eventually displaces the air, suffocating the rodent. In some instances, where there are more than one borrow entrance, the extra borrow entrance must be covered to contain the inert gas, and permit filling thereof.

Accordingly, the present invention provides a device and method to perform efficient pest extermination without the use of an explosive materials, chemical toxins or poisons that leave residual toxins which could expose raptors or humans to such residuals.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention.

We claim:

1. An apparatus for providing gas from a gas source, where said apparatus includes a proximal end and a distal end adapted for delivering the gas, said apparatus comprising:
a first tube having a proximal portion near the proximal end and a distal portion near the distal end and including one or more holes through the wall of said first tube;
a second tube coaxial with and disposed within said first tube, where said second tube has a proximal portion and a distal portion near the distal end and including one or more holes through the wall of said second tube;
a port to accept gas from the gas source; and
a passageway to provide fluid communication between said port and said one or more holes of said first tube;
where said first tube and second tube are rotatably movable between:
a first configuration, wherein at least one hole of said first tube is aligned with at least one hole of said second tube, and
a second configuration, wherein none of said one or more holes in said first tube align with any of said one or more holes of said second tube.

2. The apparatus of claim 1, further including a pointed tip at the distal portion of the first tube.

3. The apparatus of claim 1, further including a valve disposed between said port and the interior of said second tube.

4. The apparatus of claim 1, further including a handle fixedly attached to the proximal portion of the first tube.

5. The apparatus of claim 5, further including a housing at the proximal end connected to said handle, said first tube, and said second tube, where said housing is attached to said handles and said first tube, and where said housing includes a rotational support for said second tube.

6. An apparatus for providing gas from a gas source, said apparatus comprising:
a valve including a gas inlet to accept gas from the gas source;
a tube having a proximal portion and a distal portion, where said proximal portion includes a handle and is in fluid communication with said valve, and said distal portion includes one or more openings through said tube and a pointed tip; and
means for covering said one or more openings.

7. The apparatus of claim 6, where said tube is a first tube, where said one or more openings are one or more first openings, where said apparatus includes a second tube disposed within said first tube and having a proximal end near the proximal end of the first tube and a distal end near the distal end of the first tube, where said distal end of the second tube includes one or more second openings at rotationally disposed within said first tube, and where said means for covering said one or more first openings includes rotating the first tube relative to the second tube.

8. The apparatus of claim 6, further including a valve disposed between said port and the interior of said second tube.

9. The apparatus of claim 6, further including a handle fixedly attached to the proximal portion of the first tube.

10. The apparatus of claim 9, further including a housing at the proximal end connected to said handle, said first tube, and said second tube, where said housing is attached to said handles and said first tube, and where said housing includes a rotational support for said second tube.

11. A method of delivering a gas into the ground using a gas injector with a proximal end and distal end, and an outer tube and a coaxial inner tube rotationally mounted to each other and which both extend from near the proximal end to near the distal end, where said inner tube is adapted to accept a gas, and where said outer tube includes discharge ports and a pointed tip near the distal end, said method comprising:
covering the discharge ports;
inserting the pointed tip into the ground;
uncovering the discharge ports; and
activating the flow of a gas through the discharge ports.

12. The method of claim 11, where said covering the discharge ports includes rotating the inner tube relative to the outer tube.

13. The method of claim 11, where said inserting the pointed tip into the ground includes providing a downwards force on a handle of the gas injector.

14. The method of claim 11, where said uncovering the discharge ports includes rotating the inner tube relative to the outer tube.

15. The method of claim 11, where said gas injector include a valve having a trigger between a gas source and the discharge ports, and where said activating the flow of gas includes depressing the trigger.
